(19) United States
(12) Patent Application Publication
(10) Pub. No.: US 2017/0057215 A1
(43) Pub. Date: Mar. 2, 2017

(54) PERSONALIZATION OF CERAMIC OBJECTS: INKJET IMAGE TRANSFER PROCESS AND MATERIALS

(71) Applicant: BROTHER INTERNATIONAL CORPORATION, Bridgewater, NJ (US)

(72) Inventor: Kangning LIANG, Bartlett, TN (US)

(73) Assignee: BROTHER INTERNATIONAL CORPORATION, Bridgewater, NJ (US)

(21) Appl. No.: 14/843,244

(22) Filed: Sep. 2, 2015

(51) Int. Cl. B41J 2/005; B41M 5/50

(52) U.S. Cl. CPC B41J 2/0057; B41M 5/50

(57) ABSTRACT

Methods and materials allow personalizing ceramic products such as coffee mugs, plates, vases, etc. by transferring an inkjet image to the surface of a ceramic object. According to embodiments of the invention, personalizing a ceramic object may include three elements: an image receptive layer that has been deposited on a ceramic object to form an image receptive surface, an inkjet image to be transferred, and control over the image transfer process. An inkjet image is printed on an image transfer sheet, which is then brought into contact with the image receptive surface of a ceramic object. The dyes comprising the image begin to migrate into the image receptive layer of the ceramic object under suitable conditions.

### BACKGROUND

Personalization of ceramic objects such as mugs and plates often requires specialized equipment and materials. Ordinary household printers cannot accommodate the widely varied shapes and contours of these objects, and common water-soluble inks will not form permanent images on ceramic surfaces. Personalization of these objects, therefore, is often provided only by commercial workshops and stores.

What is needed, therefore, is a way for customers and hobbyists to personalize ceramic products using inkjet images with simplicity, convenience, and low cost.

### BRIEF SUMMARY

Embodiments of the invention include methods and materials for personalizing various ceramic products such as coffee mugs, plates, vases, etc., by transferring an inkjet image to the surface of a ceramic object. A home user or hobbyist can deposit a permanent image on a ceramic object by using a regular inkjet printer to print a desired image onto a specially prepared image transfer sheet and then transferring the image from the sheet to a treated ceramic object.

These methods circumvent the technical difficulties inherent in direct inkjet printing to ceramic objects, instead enabling users to personalize objects having widely varied sizes, shapes, and contours. The process is low cost and convenient, and no specialized equipment is required. According to embodiments of the invention, dye-based inkjet inks, which are widely employed in low cost home and office inkjet printers, can be used to form images on ceramic objects.

According to embodiments of the invention, personalizing a ceramic object may include three elements: an image receptive layer that has been deposited on a ceramic object to form an image receptive surface, an inkjet image to be transferred, and control over the image transfer process. Given these elements, to transfer an image, first an inkjet image is printed on an image transfer sheet, which is then brought into contact with the image receptive surface of a ceramic object. The dyes comprising the image begin to migrate into the image receptive layer of the ceramic object under suitable conditions.

The use of an image transfer sheet in embodiments of the invention rather than direct printing circumvents two major barriers: accommodating various sizes, shapes, and contours of different ceramic objects and retaining inkjet inks on a non-absorptive ceramic surface. An image transfer sheet not only greatly reduces the imaging costs, especially for low volume works, but also enables personalization of items that have irregular surface contours and are consequently difficult or even impossible to print on directly. It further enables convenient control over the amount of inks matching the capacity of the image receptive surface of the object and the quality of the transferred image.

According to embodiments of the invention, a method of transferring an image to a ceramic object comprises depositing an image receptive layer on a surface of the object, printing the image in reverse onto a portion of an image transfer sheet, placing the portion of the image transfer sheet onto which the image in reverse has been printed in contact with the image receptive layer, and separating the portion of the image from the image receptive layer.

In an embodiment of the invention, the method comprises assisting the transfer of the image to the object with heat, with moisture, or both. In an embodiment that comprises assisting the transfer of the image with moisture, transfer of the image comprises maintaining the object, which has the portion of the image transfer sheet in contact with the image receptive layer, in a moisture-saturated environment. In one such embodiment, the object is maintained in the moisture-saturated environment for 17 to 90 hours.

In an embodiment that comprises assisting the transfer of the image with heat, transferring the image comprises maintaining the object, which has the portion of the image transfer sheet in contact with the image receptive layer, in a heated oven. In one such embodiment, the object is maintained for 10 to 45 minutes in an oven having a temperature between 120 and 155° C.

In another embodiment that comprises assisting the transfer of the image with heat, the method comprises maintaining the object, which has the portion of the image transfer sheet in contact with the image receptive layer, in an operating microwave oven with a quantity of water. In one such embodiment, the object is maintained in an operating 600 W microwave oven for 4 to 4.5 minutes.

In an embodiment of the invention, depositing the image receptive layer on the surface of the object comprises applying a mixture comprising PQ-10 (polyquaternium-10) and 3GTMS (3-glycidyloxypropyl trimethoxysilane) to the surface of the object, and after applying the mixture to the surface, heating the object. In one such embodiment of the invention, the concentration of PQ-10 in the mixture is 1.35%, and the concentration of 3GTMS in the mixture is within the range 0.05% to 0.9%.

In an embodiment of the invention, the image transfer sheet comprises a plurality of distinct layers capable of being separated from each other, wherein a first one of the layers comprises a backing sheet, and a second one of the layers receives the image during printing. In an embodiment, the backing sheet is PET film. In an embodiment, the layer that receives the image during printing is a layer of polyvinyl acetate latex.

According to an embodiment of the invention, a ceramic object is capable of permanently receiving an image through contact with an image transfer sheet upon which the image has been printed. In this embodiment, a surface of the ceramic object has been prepared with an image receptive layer. In an embodiment, the image receptive layer comprises a mixture comprising a polyquaternium and 3GTMS. In one such embodiment, the polyquaternium is PQ-10.

According to an embodiment of the invention, a printable image transfer sheet is for receiving an image and transferring the image to surface of a prepared ceramic object. The image transfer sheet comprises a backing layer and a printable layer removably adhering to the backing layer. In an embodiment, the printable layer comprises polyvinyl acetate latex. In an embodiment, the backing layer comprises a layer of PET film.

In an embodiment of the invention, the dimensions of the sheet are such that the sheet can be printed upon by an inkjet printer that is configured to print upon a sheet of paper.

### BRIEF DESCRIPTION OF THE DRAWINGS

The invention is illustrated in the figures of the accompanying drawings, which are meant to be exemplary and not limiting, and in which like references are intended to refer to like or corresponding things.

FIG. 1 depicts the flow of personalizing a ceramic object according to an embodiment of the invention.

FIGS. 2a, 2b, and 2c depict conceptually the transfer of an image from an image transfer sheet to an image receptive layer on a ceramic surface according to an embodiment of the invention.

FIG. 3 depicts a ceramic coffee mug that has been treated to form an image receptive layer on its surface.

FIG. 4 depicts a treated ceramic coffee mug in partial contact with an image transfer sheet.

### DETAILED DESCRIPTION OF THE PREFERRED EMBODIMENTS

Embodiments of the invention provide a convenient and low-cost method for using images produced, e.g., with a consumer-grade inkjet printer, to personalize ceramic objects such as, for example, mugs, plates, vases, and the like. According to an embodiment of the invention, this kind of personalization may have four steps: 1) forming an image-receptive layer on a ceramic object, 2) printing an inkjet image onto an image transfer sheet, 3) transferring the inkjet image to the ceramic object, and 4) and removing the image transfer layer.

According to an embodiment of the invention, a cationic polymer, polyquaternium-10 (PQ-10), in combination with a hydroxyl-reactive agent, 3-glycidyloxypropyltrimethoxysilane (3GTMS), forms the image receptive layer on a ceramic object, and a polyvinyl acetate latex-based (PVAc) image transfer sheet may serve as a medium to carry an inkjet image. The image to be transferred is first printed to the image transfer sheet and then transferred to the image receptive surface of a ceramic object through direct contact between the image transfer sheet and the image receptive medium. In addition, the image transfer process can be accelerated by controlling the environmental factors such as heat and moisture.

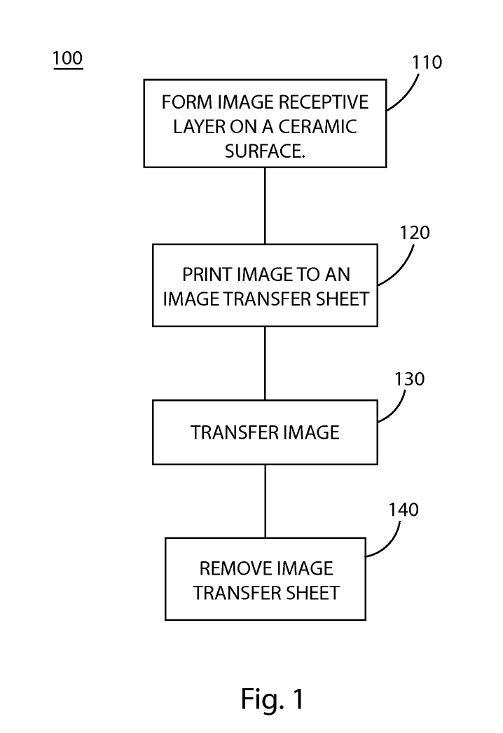

FIG. 1 is a block diagram that illustrates the main steps of personalizing 100 a ceramic object according to an exemplary embodiment of the invention. In block 110, an image receptive layer is formed on a ceramic surface. In block 120, an image is printed, e.g., with a commercially available ink jet printer, onto a specially prepared image transfer sheet. In block 130, the image is transferred from the image transfer sheet to the image receptive layer, e.g., by direct contact between the image transfer sheet and the image receptive layer, and in block 140, the image transfer sheet is removed from the image receptive layer.

1. Forming an Image Receptive Layer on Ceramic Surface

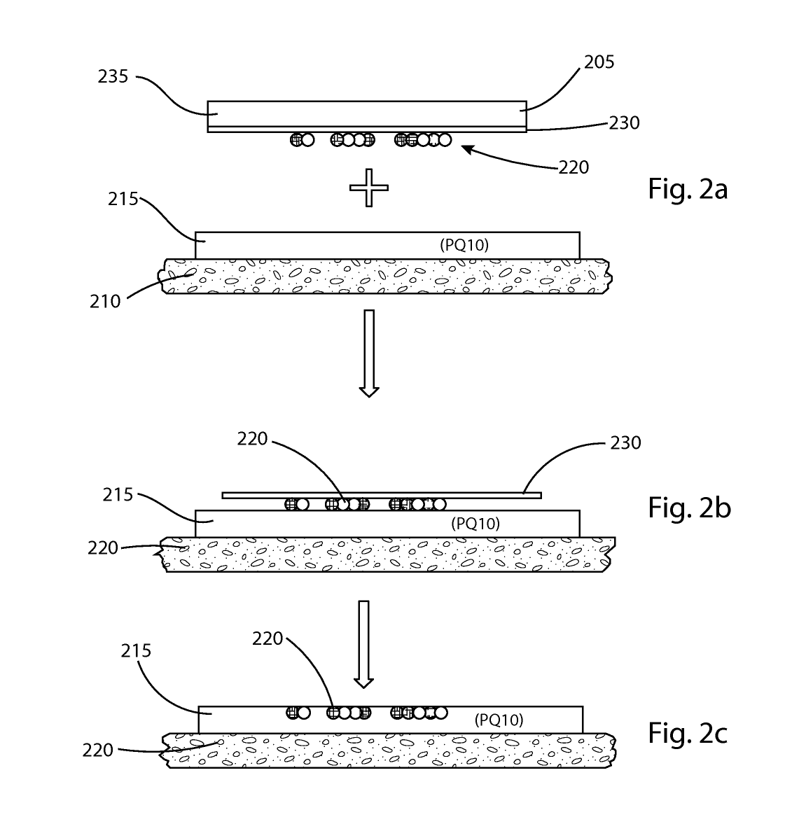

FIGS. 2a, 2b, and 2c depict conceptually an image transfer sheet 205 (bearing an image) and a ceramic object 210 that bears an image receptive layer 215.

It is well known in the art that dye-based inkjet inks are typically made of water-soluble dyes that contain multiple negatively charged groups—predominantly sulfonate and carboxylate—and the dye molecules 220 therefore bear negative charges when dissolved in water. These dyes, containing sulfonate groups, carboxylate groups, or both, can react with a proper counterion (cation) to form a water-insoluble salt. A great many organic cations, such as, e.g., quaternary ammonium and pyridinium, are known to react with these dyes to form water-insoluble salts.

Embodiments of the invention may take advantage of these properties. For example, when a ceramic surface 210 bears an image receptive layer 215 that includes a cationic polymer, direct contact between an inkjet image formed from the dyes and the image receptive layer 215 can let the dyes 220 migrate into the image receptive layer 215 and bond to the cations, thereby forming a horizontally-flipped version of the original image on the image receptive layer 215. Further, many inkjet dyes have multiple anionic groups (not pictured); as a result, crosslinking can take place within the image receptive layer 215 such that one dye molecule 220 can bind to cations of different polymer molecules. Such crosslinking can increase the adhesion between the dyes and the image receptive layer, making the image relatively more durable.

In an embodiment of the invention, the image receptive layer may be formed from the water-soluble cellulose-based cationic material polyquaternium-10. (PQ-10 is well known in disparate arts, and it is widely available commercially.) PQ-10 may be particularly suitable for the image receptive layer on a ceramic object because it possesses multiple quaternary ammonium cations and also a large number of hydroxyl groups, which can further enhance adhesion of the image receptive layer to the ceramic surface, e.g., through reactions between the hydroxyl groups of PQ-10 and 3GTMS (epoxy and alkoxysilane groups), and/or between the hydroxyl groups of PQ-10 and hydroxyl groups of the ceramic surface.

It will be appreciated by those skilled in the art that ceramic materials often possess hydroxyl groups at the ceramic/air interface, so chemical agents such as alkoxysilanes may be used to react with them to modify the interfacial properties of a ceramic surface. Of particular relevance to embodiments of the invention, a chemical agent such as 3GTMS, which contains multiple alkoxysilane groups, when present in a PQ-10 image receptive layer deposited on a ceramic surface, can react with the hydroxyl groups of both the ceramic and the PQ-10. As a consequence, it potentially causes further crosslinking in the image receptive layer, but it also covalently links that layer to the ceramic interface, thereby enhancing the adhesion of the image receptive layer to the ceramic surface.

Besides PQ-10, many polyquaterniums can be used as the material for an image receptive layer according to embodiments of the invention. Suitable polyquaterniums known to the art include (among others) polyquaternium-5 (copolymer of acrylamide and quaternized dimethylammoniumethyl methacrylate), polyquaternium-7 (copolymer of acrylamide and diallyldimethylammonium chloride), polyquaternium-15 (acrylamide-dimethylaminoethyl methacrylate methyl chloride copolymer), polyquaternium-32 (poly(acrylamide 2-methacryloxyethyltrimethyl ammonium chloride)), and polyquaternium-39 (terpolymer of acrylic acid, acrylamide and diallyldimethylammonium chloride).

In an exemplary embodiment of the invention, a formulation (PQ-10-3GTMS) consisting of PQ-10, 3GTMS, and a small amount of Triton™ X-100 is used to form an image receptive layer on a ceramic object. The PQ-10-3GTMS formulation may be deposited on the surface of a ceramic object, and then the image receptive layer may be cured by heating the object in an oven.

More specifically, in one illustrative example, the image receptive layer may be composed of PQ-10 and 3GTMS with a small amount of Triton™ X-100 (0.1%). In exemplary formulations, using water as a solvent, the concentration of PQ-10 may vary from 0.1% to 5%, with a preferred concentration being 1.35%; the concentration of 3GTMS may vary from 0.05% to 0.9%, with a preferred concentration being 0.15%; and the concentration of Triton™ X-100 can vary from 0.01% to 0.5%, with a preferred concentration being 0.1%.

To prepare that mixture, one may put a 1.35% PQ-10 solution, containing 0.1% Triton™ X-100, into a plastic bottle and then add a desired amount of 3GTMS to it. The materials may be mixed on an oscillator for 1 minute and then on a roller for 30 minutes to result in a homogeneous mixture. The bottle may then stand for a time (which is not critical) to clear up air bubbles in the mixture.

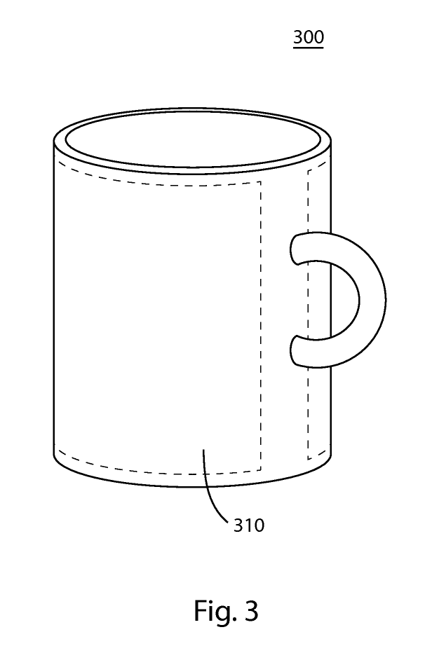

In one application, a ceramic object, e.g., a white ceramic mug, may be cleaned by rinsing and wiping it in water. After the object dries, an amount of the formulation may be dispensed on the surface, e.g., by using a soft paint brush to form an even liquid coat. (A coat is sufficiently “even” in this sense if it appears roughly even on inspection by the naked eye.) Coating a ceramic mug, for example, may use about 3 ml of the solution. FIG. 3 depicts a mug 300 with an image receptive layer 310 according to an embodiment of the invention.

In this application, the image receptive layer 215 may be cured by heat: e.g., the object may then be placed in an oven, e.g., for 30 minutes, and the oven temperature may be maintained, e.g., in the range of 120 to 155° C. After this time, the image receptive surface may be ready to receive an image.

2. Printing an Image to an Image Transfer Sheet

Printing directly onto a ceramic surface can be difficult. For example, ceramic mugs and plates may have curved surfaces with varying contours, which make it difficult to maintain the precise and constant distance between the inkjet head and the printing surface that inkjet printing requires. Further, inkjet printing directly upon a ceramic surface often requires precise control over the amount of inks deposited on a mug surface to prevent smearing the image by excessive ink because a ceramic mug surface usually has very limited capacity for absorption of inks.

Embodiments of the invention circumvent these hurdles through an indirect image forming method, in which an inkjet image printed on an image transfer sheet is the source of image. This method not only completely avoids unwanted running of excessive inks on the surface of a ceramic object, but conveniently accommodates to its surface contour and (to a certain extent) its surface topology (roughness).

According to an embodiment of the invention, an image transfer sheet 205 (FIG. 2a) may comprise a layer of polyvinyl acetate latex (PVAc) 230 on a polyester (PET) film 235. A PVAc layer 230 advantageously can receive a high-quality image from an inkjet printer. But what may be more important in embodiments of the invention is that PVAc does not chemically associate with anionic dyes 220, allowing the dyes 220 to freely migrate to an image receptive layer 215 when they are in direct contact.

PVAc has other properties that may be advantageous in connection with embodiments of the invention. PVAc is hydrophilic, and this property can both facilitate the transfer of the image and ease separation of the PVAc 230 layer from the surface after the image has been transferred.

Separating the PVAc layer 230 from the PET backing film 235 after printing (but before transferring the image) may itself provide two advantages. First, a freely standing PVAc layer 230 may be soft and flexible and thus made to conform to various surface topologies and contours. Second, removing the PET backing film 235 during the image transfer may also prevent the film 235 from interfering with the transfer.

The PET backing layer 235 may add strength to the image transfer sheet 205, making the sheet 205 easier to handle during printing and reducing the likelihood of damaging the PVAc layer 230.

In one exemplary embodiment of the invention, the PVAc used may be Elmer's® Glue-All® multi-purpose glue, which can be, e.g., applied with a glass rod onto PET film, thereby forming a layer (for example) roughly 75 microns thick, and dried at room temperature to form the image transfer sheet 205. For example, in one illustrative embodiment, the glue may be applied to an 8½″×11″ rectangular piece of white PET film, which may then be left to dry at room temperature for two hours.

Many other water-absorbing or water-soluble polymers can be used to construct image transfer sheets according to embodiments of the invention. Suitable polymers include, for example, polyvinylpyrrolidone (PVP), polyvinyl alcohol (PVA), poly(methyl vinyl ether) (PVME), polyurethane latex (PU), and mixtures of these polymers, their copolymers, and latices. Besides PET, other plastics, such as polyethylene, polypropylene, and polyamide may also be suitable backing materials for image transfer sheets.

According to embodiments of the invention, an image may be printed on an image transfer sheet by a conventional inkjet printer using conventional inks. In exemplary embodiments, printing was done by Brother™ MFC-J6710DW or MFC-J6910DW inkjet printers. With those printers, it was found that the best image quality was achieved when the printer setting for Media Type was “Inkjet Paper”, and the setting for Print Quality was “Photo”. It will be appreciated that the image size may depend, e.g., on the size of the surface that the image is meant to cover.

After an image has been printed on the PVAc layer of an image transfer sheet, the PVAc layer carrying the image may be peeled away from the PET backing film. The image-bearing side of the PVAc layer may then be placed in direct contact with the image receptive layer of a ceramic object.

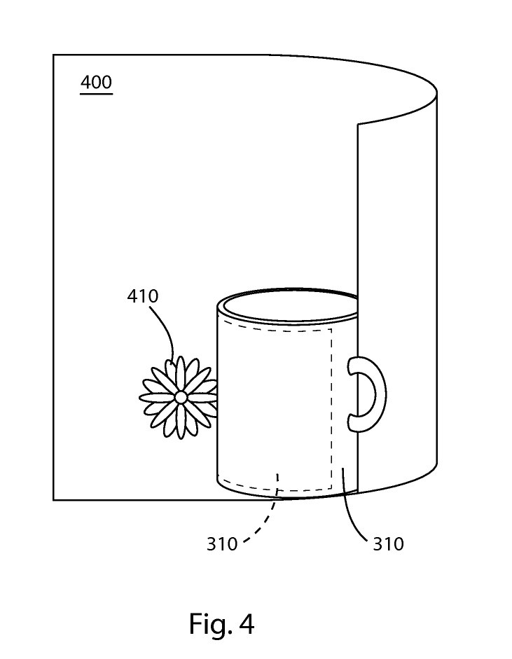

FIG. 4 depicts a PVAc layer 400 of an image transfer sheet (not pictured) that has been partially placed in contact with a ceramic coffee mug 300 that bears an image receptive surface 310 according to an embodiment of the invention. The PVAc layer 400 has had an image 410 printed on it. Portions of the image 410 in contact with the image receptive surface 310 may then be transferred by the contact from the PVAc layer to the ceramic mug 300.

It will be appreciated that air may be trapped in pockets between the PVAc layer and image receptive layer, and that air may degrade the transferred image by keeping parts of the PVAc layer from touching the image receptive surface. In an embodiment of the invention, an air pocket that forms this way can be punctured with a pointy object such as a needle and gently pressed, e.g., with a finger, to release the air.

3. Controlling the Image Transfer Process

Ambient conditions may suffice, in connection with embodiments of the invention, to cause satisfactory amounts of dyes to migrate from the PVAc layer to the image receptive layer. But it will be appreciated that it may be preferable to speed up the image transfer process by varying environmental elements such as moisture and temperature.

For example, when the PVAc layer absorbs moisture, dye molecules on the PVAc layer may move more quickly across the interface to react with the PQ-10 of the image receptive layer. But contact with liquid water can damage the PVAc layer, so the PVAc layer may in an embodiment of the invention be induced to absorb water vapor from the air. Moisture-assisted transfer can be achieved, e.g., by conducting the image transfer process in a moisture-saturated environment at a certain temperature, for example, an enclosed container containing liquid water.

For example, in connection with an exemplary embodiment of the invention, a treated ceramic mug, in contact with an image-bearing PVAc layer, may be placed into a plastic container or bag having a saturated water vapor environment at room temperature and maintained in the vapor for 17 to 90 hours. Afterwards, while still plasticized by the water vapor, the PVAc layer may be gently peeled away from the mug.

To keep moisture from condensing on the PVAc layer (which can damage the image), it may be important in an embodiment of the invention to maintain the temperature of the PVAc layer close to or the same as that of the container, and doing so may be achieved by controlling the temperature of the ceramic surface, Typically, room temperature may be preferred because of easy control and handling.

Alternatively, heat may accelerate the image transfer. At elevated temperatures, the PVAc layer may be softened or even melted, allowing closer contact between the image and the image receptive layer. Dyes also move more vigorously at higher temperatures, so applying heat can hasten an image transfer. But the temperature and the duration of heating must be controlled to achieve satisfactory transfer of dyes without significantly degrading the dyes (the image) and the PVAc layer. According to embodiments of the invention, this heat-assisted transfer process may take place in a temperature-controlled oven.

For example, in connection with embodiments of the invention, a treated ceramic mug, in contact with an image-bearing PVAc layer, may be heated for 10 to 45 minutes in an oven having a temperature between 120 and 155° C. After it cools to room temperature, the mug may be rinsed with water for 2 to 10 minutes or until the PVAc layer is washed away. In an embodiment of the invention, spraying water onto the PVAc layer from a consumer water sprayer may speed removal of the PVAc.

Another way to use heat and moisture to speed image transfer, in connection with an embodiment of the invention, involves a household microwave oven. For example, a mug, treated and placed in contact with an image-bearing PVAc layer, may be partially filled with water and placed in a microwave oven, which may then be turned on. In connection with an exemplary embodiment, a treated coffee mug of typical size was filled with roughly 250 ml of water at 24° C. and heated in a 600 W microwave oven for 4 to 4.5 minutes. At the end of the microwave heating, the water temperature was measured at 96° C. while the mug surface temperature measured 89° C. The mug was allowed to cool down to 37° C., and the water was discarded. After the PVAc layer on the mug was rinsed with water for about 2 minutes, it was gently peeled away and discarded.

It will be appreciated that the above times, temperatures, volume of water, and microwave oven output are not critical. Any values that allow the water to be heated without boiling over the top of the mug and do not damage the PVAc layer, mug, or oven are acceptable.

4. Removing Image Transfer Layer

After the desired amount of the dyes has been transferred from the PVAc layer, and the image transfer is considered complete, the final step according to an embodiment of the invention is to separate the PVAc layer from the transferred image, which now permanently resides on the receptive layer of the ceramic object.

In embodiments of the invention, just how to remove the PVAc layer may depend upon the image transfer process used. For example, if the transfer was moisture-assisted at room temperature, the PVAc layer can in an embodiment of the invention simply be peeled away while it is still fully moisturized.

But the heat-assisted transfer process may in an embodiment of the invention lead to a hard and brittle PVAc layer that can not be peeled away without damaging the transferred image. In this case, the whole ceramic object can be immersed into water until the PVAc layer is saturated. The PVAc layer can then be rinsed away with water. Alternatively, the PVAc layer can be sprayed with water (e.g., from a household sprayer) to break up the PVAc layer and then the object can be rinsed with water to ensure complete removal of the PVAc layer.

When the image transfer layer is made of a water-soluble polymer such as PVP, its removal may be as simple as rinsing it with water to dissolve away the polymer while the transferred image remains on the ceramic surface.

The description of the claimed invention in terms of certain embodiments is meant to be illustrative, not limiting. It will be appreciated by those skilled in the relevant arts that the principles of the invention apply to many variations of the described methods and materials. The scope of the invention is therefore expressed by the claims below and not limited by any particular embodiment in this description.

I claim:

1. A method of transferring an image to a ceramic object, the method comprising:
depositing an image receptive layer on a surface of the object;
printing the image in reverse onto a portion of an image transfer sheet;
placing the portion of the image transfer sheet onto which the image in reverse has been printed in contact with the image receptive layer; and
separating the portion of the image from the image receptive layer.

2. The method of claim 1, comprising assisting the transfer of the image to the object with heat, with moisture, or both.

3. The method of claim 2, comprising assisting the transfer of the image with moisture, wherein assisting the transfer of the image comprises maintaining the object having the portion of the image transfer sheet in contact with the image receptive layer in a moisture-saturated environment.

4. The method of claim 3, comprising maintaining the object in the moisture-saturated environment for 17 to 90 hours.

5. The method of claim 2, comprising assisting the transfer of the image with heat, wherein assisting the transfer of the image comprises maintaining the object having the portion of the image transfer sheet in contact with the image receptive layer in a heated oven.

6. The method of claim 5, comprising maintaining the object in the oven for 10 to 45 minutes in an oven having a temperature between 120 and 155° C.

7. The method of claim 2, comprising assisting the transfer of the image with heat, wherein assisting the transfer of the image comprises maintaining the object having the portion of the image transfer sheet in contact with the image receptive layer in an operating microwave oven with a quantity of water.

8. The method of claim 7, comprising maintaining the object in an operating 600 W microwave oven for 4 to 4.5 minutes.

9. The method of claim 1, wherein depositing the image receptive layer on the surface of the object comprises:
applying a mixture comprising PQ-10 and 3GTMS to the surface of the object; and
after applying the mixture to the surface, heating the object.

10. The method of claim 9, wherein the concentration of PQ-10 in the mixture is 1.35%, and the concentration of 3GTMS in the mixture is within the range 0.05% to 0.9%.

11. The method of claim 1, wherein the image transfer sheet comprises a plurality of distinct layers capable of being separated from each other, wherein a first one of the layers comprises a backing sheet, and a second one of the layers receives the image during printing.

12. The method of claim 11, wherein the backing sheet is PET film.

13. The method of claim 11, wherein the layer that receives the image during printing is a layer of polyvinyl acetate latex.

14. A ceramic object capable of permanently receiving an image through contact with an image transfer sheet upon which the image has been printed, wherein a surface of the ceramic object has been prepared with an image receptive layer.

15. The ceramic object of claim 14, wherein the image receptive layer comprises a mixture comprising a polyquaternium and 3GTMS.

16. The ceramic object of claim 15, wherein the polyquaternium is PQ-10.

17. A printable image transfer sheet for receiving an image and transferring the image to surface of a prepared ceramic object, the image transfer sheet comprising:
a backing layer; and
a printable layer removably adhering to the backing layer.

18. The printable image transfer sheet of claim 17, wherein the printable layer comprises polyvinyl acetate latex.

19. The printable image transfer sheet of claim 18, wherein the backing layer comprises a layer of PET film.

20. The printable image transfer sheet of claim 17, wherein the dimensions of the sheet are such that the sheet can be printed upon by an inkjet printer that is configured to print upon a sheet of paper.
